(19) United States
(12) Patent Application Publication
(10) Pub. No.: US 2007/0234913 A1
(43) Pub. Date: Oct. 11, 2007

(54) Drive for a rotary printing press

(75) Inventors: Roland Angert, Pfungstadt (DE); Jens Friedrichs, Neckargemund (DE); Christian Gorbing, Heidelberg (DE); Gerald Erik Hauptmann, Bammental (DE); Michael Kruger, Edingen-Neckarhausen (DE); Olaf Lorenz, Ludwigshafen (DE); Markus Mohringer, Weinheim (DE); Frank Schaum, Neckargemund (DE); Thomas Schmidt, Eppelheim (DE); Martin Seipel, Schriesheim (DE); Volker Weindel, Leutershausen (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/784,827

(22) Filed: Apr. 10, 2007

(30) Foreign Application Priority Data
Apr. 10, 2006 (DE) DE 102006016758.9

(51) Int. Cl. B41F 5/00

(52) U.S. Cl. 101/216

(57) ABSTRACT

A drive for a rotary printing press makes a reliable transmission of high torques possible and, with low structural expenditure, setting of the phase in the main drive gear train. In the drive for a rotary printing press, two adjacent transfer drums are mounted with shaft journals in side walls, a gearwheel of the gearwheel mechanism is disposed fixedly in terms of rotation on the shaft journals and the gearwheels are not in direct engagement with one another. The gearwheels of the adjacent transfer drums are permanently in engagement in each case with one intermediate gear. The gearwheels of the adjacent transfer drums and the intermediate gears are kept at a spacing from one another in each case with one lever. The intermediate gears are kept at a spacing in each case from one another with a coupler. The coupler can be disconnected and the engagement of the teeth of the intermediate gears can be canceled.

### CROSS-REFERENCE TO RELATED APPLICATION

This application claims the priority, under 35 U.S.C. §119, of German application DE 10 2006 016 758.9, filed Apr. 10, 2006; the prior application is herewith incorporated by reference in its entirety.

### BACKGROUND OF THE INVENTION

### Field of the Invention

The invention relates to a drive for a rotary printing press. The drive has a gearwheel mechanism for transmitting a rotational movement of transfer drums during transport of a printing material, a coupler in the gearwheel mechanism for producing and interrupting a transmission of torque, and at least one motor for feeding a torque into the gearwheel mechanism.

Sheet-fed printing presses having a plurality of printing units in an inline construction are known, in which impression cylinders and drums which convey the sheets are driven by way of a gearwheel mechanism. The cylinders and drums are held rotatably in bearings by way of shaft journals in side walls. Gearwheels of the gearwheel mechanism are disposed fixedly in terms of rotation on the shaft journals. The gearwheels form a main drive gear train, into which a torque is fed by a motor during printing. During printing, the cylinders and drums have a defined rotational phase position, with the result that the sheets which are held in grippers can be transferred in register from a cylinder or a drum to a cylinder or an adjacent drum which lies downstream.

Sheet-fed printing presses are known, the operating type of which can be set optionally to printing on only one side or to printing on both sides of the sheets. In order to set printing on both sides, a turner apparatus is actuated in the conveying path of the sheets. The rotational phase positions of the cylinders and drums differ during printing on only one side and in perfecter operation. Published, non-prosecuted German patent application DE 42 23 189 A1, corresponding to U.S. Pat. No. 5,398,606, discloses an apparatus which makes it possible to disengage the main drive gear train and to set the rotational phase of the cylinders and drums ahead of a turner apparatus with respect to the rotational phase position of the cylinders and drums after the turner apparatus to the desired operating type. The apparatus contains a coupling which can disconnect a gearwheel from the shaft journal of a turner drum. The coupling is configured as a friction coupling, friction faces of the gearwheel which can be disconnected and a gearwheel which is connected fixedly in terms of rotation to the shaft journal are pressed against one another during printing by a spring assembly. The gearwheel which can be disconnected and the gearwheel which is connected fixedly in terms of rotation to the shaft journal are permanently in engagement with the gearwheels of an adjacent storage drum and an impression cylinder.

The torques which can be transmitted in the main drive gear train are limited by the construction of the gearwheels, the connection to the shaft journals and by couplings. In particular in machines with a large number of printing units and large sheet formats which are to be printed, static and dynamic torques occur which can lead to a failure of the coupling. If the coupling fails, the rotational phase position of the printing units changes, with the result that printing errors are produced or, in the extreme case, grippers collide with drum bodies.

Published, non-prosecuted German patent application DE 102 02 385 A1 discloses a printing unit, in which intermediate gearwheels which are connected to a coupler are provided for changing the angular position between a printing form cylinder and a blanket cylinder, which intermediate gearwheels are in engagement with one another and with the drive gearwheels of the printing form cylinder and the blanket cylinder. The drive gearwheels of the printing form cylinder and the blanket cylinder are kept in each case at a spacing with respect to the respective intermediate gearwheel by a coupler. The coupler between the intermediate gearwheels can be moved by way of an actuator in order to set the angular position. The movement range of the coupler is limited, with the result that only small changes in the angular position can be set.

In a printing press according to published, non-prosecuted German patent application DE 39 03 093 A1, a storage drum and a turner drum are disposed parallel to the sheet feed during printing on only one side of the sheets, for turning of sheets. The storage drum and the turner drum are connected to a coupler. The storage drum and the turner drum are connected in each case by way of a swinging arm to a transfer drum and an impression cylinder. During printing on only one side of the sheets, the storage drum and the turner drum are thrown off. The swinging arms and the coupler are disposed pivotably in order to set different sheet formats and in order to adjust the gripper opening cams. As a result of the parallel configuration of the turner apparatus, it is not necessary to decouple the sheet-guiding cylinders which are disposed behind the turner apparatus and to adjust their rotary position.

### SUMMARY OF THE INVENTION

It is accordingly an object of the invention to provide a drive for a rotary printing press that overcomes the above-mentioned disadvantages of the prior art device of this general type, which drive makes reliable transmission of high torques possible and, with low structural expenditure, sets the phase in the main drive gear train.

With the foregoing and other objects in view there is provided, in accordance with the invention, a drive for a rotary printing press. The rotary printing press has side walls, two adjacent transfer drums, and shaft journals mounting the two adjacent transfer drums in the side walls. The drive contains a gearwheel mechanism for transmitting a rotational movement of the transfer drums during transport of a printing material, a coupler disposed in the gearwheel mechanism for producing and interrupting a transmission of torque, at least one motor for feeding the torque into the gearwheel mechanism, levers, and intermediate gears having teeth. The gearwheel mechanism has gearwheels, each of the gearwheels is disposed fixedly in terms of rotation on one of the shaft journals and the gearwheels are not in direct engagement with one another. Each of the gearwheels for the adjacent transfer drums are permanently in engagement in each case with one of the intermediate gears. The gearwheels for the adjacent transfer drums and the intermediate gears are kept at a spacing from one another in each case with one of the levers. The intermediate gears are kept at a spacing in each case from one another with the coupler. The coupler can be disconnected and an engagement of the teeth of the intermediate gears can be canceled.

According to the invention, gearwheels of adjacent transfer drums are not in engagement with one another, but are in engagement permanently with intermediate gears. The intermediate gears are in engagement with one another permanently. The gearwheels of the transfer drums and those of the intermediate gears are kept at a spacing by way of levers. The intermediate gears are kept at a spacing by way of a coupler. The coupler can be disengaged, with the result that the teeth of the gearwheels of the intermediate gears can be moved out of engagement and the rotational angle position of the transfer drums with respect to one another can be set. When the coupler is active between the intermediate gears, the levers and the coupler can be moved by way of a positioning apparatus, with the result that precision setting is possible of the rotational phase between the transfer drums.

The invention can be used, in particular, in sheet-fed rotary printing presses, where a storage drum and a turner drum are driven in a main drive gear train and, for changing over between printing on one side to printing on both sides of the sheets, the main drive gear train has to be disengaged temporarily for setting of the phase. A transmission of torque via the intermediate gears is reliable. The disconnection of the main drive gear train between the intermediate gears can be implemented inexpensively and requires a small amount of installation space.

Other features which are considered as characteristic for the invention are set forth in the appended claims.

Although the invention is illustrated and described herein as embodied in a drive for a rotary printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side sectional view of a multiple-color sheet-fed printing press having a turner apparatus according to the invention;

FIG. 2 is a diagrammatic, plan view of a gear mechanism for driving a storage drum and a turner drum;

FIGS. 3-5 are diagrammatic illustrations for showing a setting of a phase between a storage drum and a turner drum;

FIG. 6 is a diagrammatic illustration of a gearwheel mechanism for precision setting of the phase;

FIG. 7 is a diagrammatic illustration of a cam mechanism for precision setting of the phase; and

FIG. 8 is a diagrammatic illustration of a coupler which is divided in two for disengaging intermediate gears.

### DESCRIPTION OF THE PREFERRED EMBODIMENTS

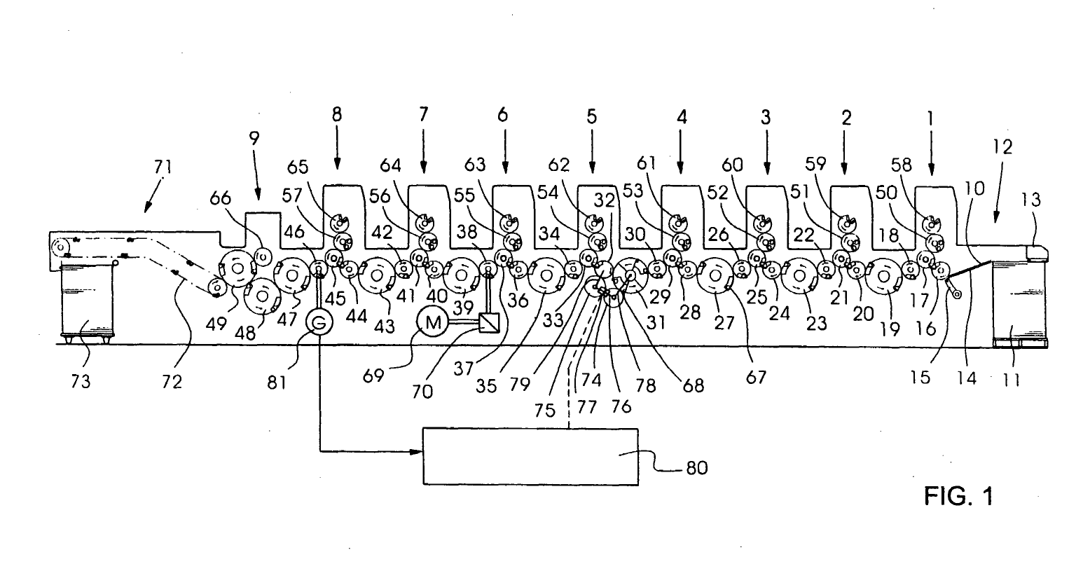

Referring now to the figures of the drawing in detail and first, particularly, to FIG. 1 thereof, there is shown a perfector printing press having eight printing units 1-8 and a varnishing unit 9 for printing on sheets 10. A feeder 12 having a suction head 13, a creeper table 14 and swinging grippers 15 is provided for separating sheets 10 from a stack 11 and for conveying them to the first printing unit 1. Transfer drums 16-49 are provided for conveying the sheets 10 through the printing press. The transfer drums 17, 21, 25, 29, 33, 37, 41, 45, 49 are configured as impression cylinders and interact with transfer cylinders 50-57. The transfer cylinders 50-57 interact with form cylinders 58-65. In the varnishing unit, the transfer drum 49 interacts directly with a form cylinder 66. During passage through a press nip between a transfer cylinder 50 to 57 and an impression cylinder 17, 21, 25, 29, 37, 41, 45, 49, the sheets 10 are printed with color separation. The color separation of a color separation image is transferred from the respective form cylinder 58-65 onto a transfer cylinder 50-57. The color separation image is transferred from the respective transfer cylinder 50-57 to a surface of the sheet 10. In the varnishing unit, the sheets 10 are given in each case a final varnish coat on that side of the sheet 10 which was printed last. All transfer drums 16-49 which guide sheets 10 have gripper configurations 67 for gripping a leading edge of the sheets 10. The transfer drum 31 has additional gripper configurations 68 for holding a trailing edge of the sheet 10. The transfer drums 16-49, the transfer cylinders 50-57 and the form cylinders 58-66 are coupled to one another in a gearwheel mechanism. In order to drive the printing press, a motor 69 is provided which feeds a torque to a shaft of the transfer drum 38 via a gear mechanism 70. The completely printed sheets 10 are conveyed onto a stack 73 in a deliverer 71 having a chain gripper system 72.

The printing press can be changed over from printing on only one side of the sheets 10 to printing on both sides. In perfecter operation, the printing units 1-4 serve for printing on the front side and the printing units 5-8 and the varnishing unit 9 serve for printing on the rear side of the sheets 10. The transfer drums 31, 32 are configured between the printing units 4 and 5 as a storage drum and a turner drum. During printing on both sides, the phase positions of the gripper configurations 67, 68 are set in such a way that the edge which trails in the printing units 1 to 4 is conveyed further as the leading edge from the printing unit 5.

There is no direct drive connection between the drive gearwheel of the storage drum 31 and the turner drum 32, but rather via intermediate gears 74, 75 which are kept at a spacing by way of a coupler 76. The intermediate gears 74, 75 are assigned a coupling configuration 77 which disengages or closes the coupler 76 in order to set the phase position of the gripper configurations 67, 68 and brings the intermediate gears 74, 75 out of or into engagement. The intermediate gear 74 and the intermediate gear 75 are kept at a spacing with respect to the storage drum 31 and with respect to the turner drum 32 by swinging arms 78 and 79. The remote-controlled coupling configuration 77 is connected to a control device 80. Setting of the phase is carried out by way of the motor 69 or an additional adjusting motor and is monitored on the shaft of the transfer drum 46 by way of a rotary encoder 81. The rotary encoder 81 and the motor 69 are likewise connected to the control device 80.

In printing operation, the coupling configuration 77 is closed, with the result that, starting from the motor 69 via the coupling configuration 77, a torque is transmitted to the elements which are to be driven in the printing units 1 to 4.

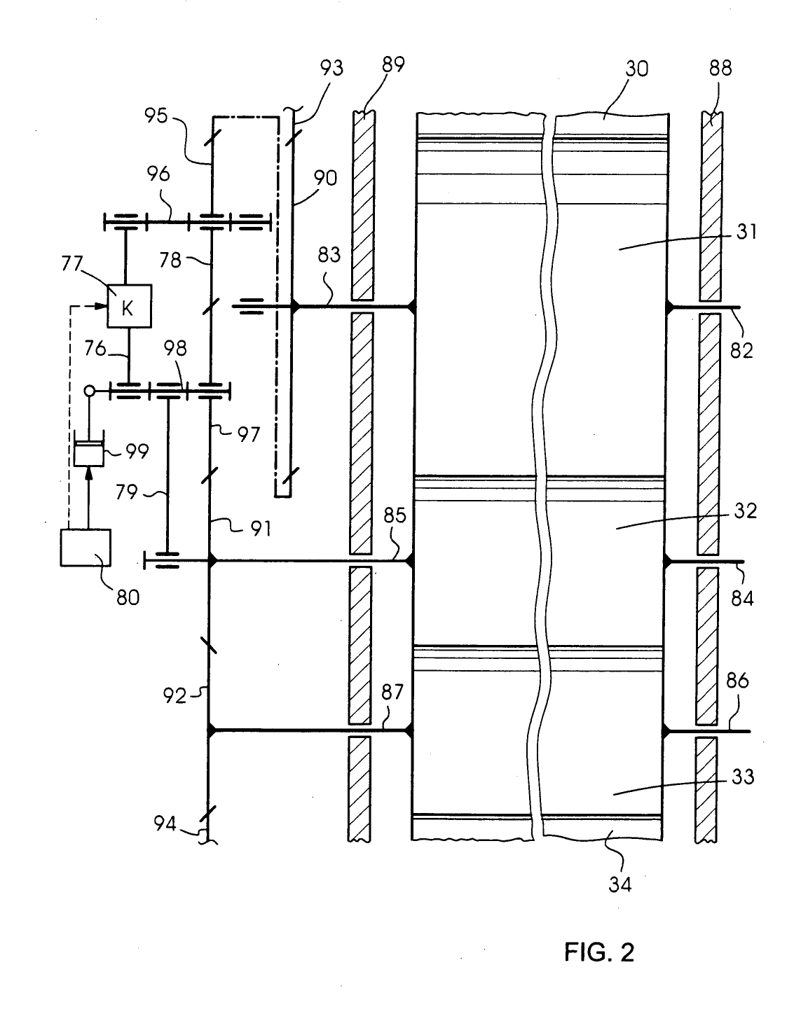

In the following text, the method of operation of the intermediate gears 74, 75 and the coupling configuration 77 is to be described using FIGS. 2 to 6. If designations which have already been introduced are used in the following description, they are elements with an equivalent function.

As shown in plan view in FIG. 2, the storage drum 31, the turner drum 32 and the impression cylinder 33 having shaft journals 82 to 87 are mounted rotatably in side walls 88, 89 of the printing press. Helically toothed gearwheels 90 to 92 are disposed fixedly in terms of rotation on the shaft journals 83, 85, 87. The gearwheels 90, 92 are connected to further gearwheels 93, 94 of the main drive gear train. The gearwheels 90, 91 lie in different planes and are not in engagement with one another. The gearwheel 90 is in engagement with an intermediate gear 95, which is shown symbolically by a dashed line. The intermediate gear 95 has the diameter of the intermediate gear 91. The intermediate gear 95 is mounted on an axle pin 96. The shaft journal 83 and the axle pin 96 are kept at a spacing by way of the swinging arm 78. The gearwheel 91 is in engagement with an intermediate gear 97 and is mounted on an axle pin 98. The shaft journal 85 and the axle pin 98 are kept at a spacing by way of a swinging arm 79. The axle pins 96, 98 are kept at a spacing by way of the coupler 76. The coupler 76 is assigned the coupling configuration 77. The axle pin 98 is coupled to a hydraulic actuator 99 which is connected to the control device 80.

During printing, the torque flow leads from the gearwheel 90 of the storage drum 31 to the intermediate gear 95, from the intermediate gear 95 to the intermediate gear 97 and from the intermediate gear 97 to the gearwheel 91 of the turner drum 32. The gearwheel 91 is the first gearwheel in the gearwheel train of that part of the printing press which lies behind the turner apparatus. In order that the torque can be transmitted in the gearwheel train from the plane of the gearwheel 90 into the plane of the gearwheel 91, one of the intermediate gears 95, 97 has double the width. During printing, the coupler 76 is fixed on the side wall 89. The connection of the coupler 76 to the side wall 89 can be released for a phase adjustment between the gearwheels 90 and 91.

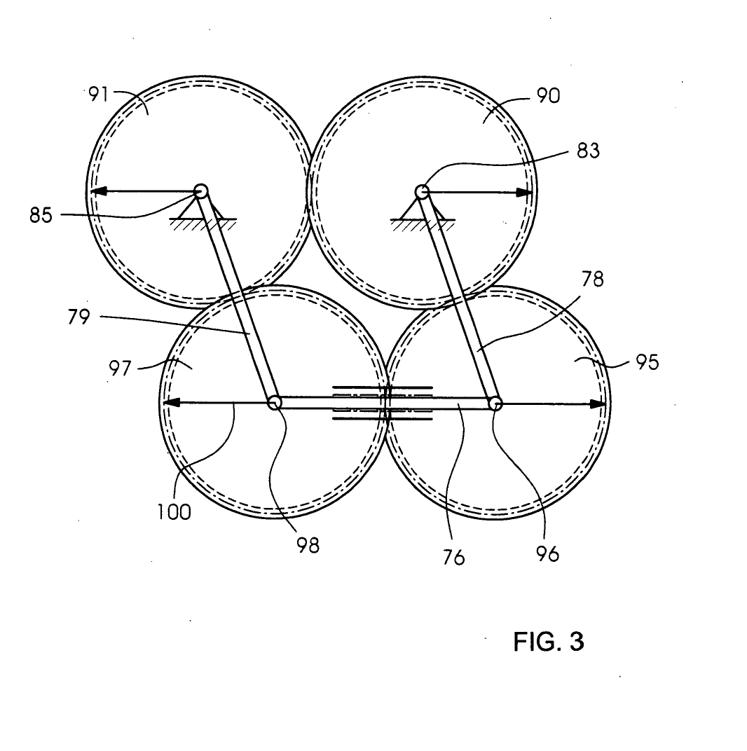

FIGS. 3 and 4 show two different positions of the swinging arms 78, 79 and of the coupler 76. The phase positions of the gearwheels 90, 91 and the intermediate gears 95, 97 are identified in each case with a phase arrow 100. In FIG. 3, the phase positions are in an initial position. If the swinging arms 78, 79 and the coupler 76 are pivoted or pushed into the positions which are shown in FIG. 4 by the actuator 99, the phase positions of the gearwheel 91 and the intermediate gears 95, 97 are changed by an angle α with respect to the initial position. The phase position can also be set in an infinitely variable manner during printing.

If the printing press is changed over from printing on one side to printing on both sides of the sheets, the phase position of the gearwheels after the turner drum 38 has to be adjusted with respect to the phase position of the gearwheels before the turner drum 32 by a relatively great amount. This relatively great amount cannot be achieved solely by pivoting of the swinging arms 78, 79 and by displacement of the coupler 76. A mechanism, in particular a threaded spindle 101, with which the length 1 of the coupler 76 can be increased, is situated on the coupler 76. If, as shown in FIG. 5, the coupler 76 is extended to such an extent that the intermediate gears 95, 97 are out of engagement, the main drive gear train is disconnected and the phase position can be adjusted by the abovementioned relatively great amount. After the adjustment of the phase position, the length l of the coupler 76 is again reduced by way of the threaded spindle 101 to such an extent that the intermediate gears 95, 97 are in engagement again. In order that the intermediate gears 95, 97 can be brought into engagement again, the adjustment of the phase position is performed in such a way that the rotated intermediate gear 95 or 97 is rotated only by a multiple of the tooth pitch.

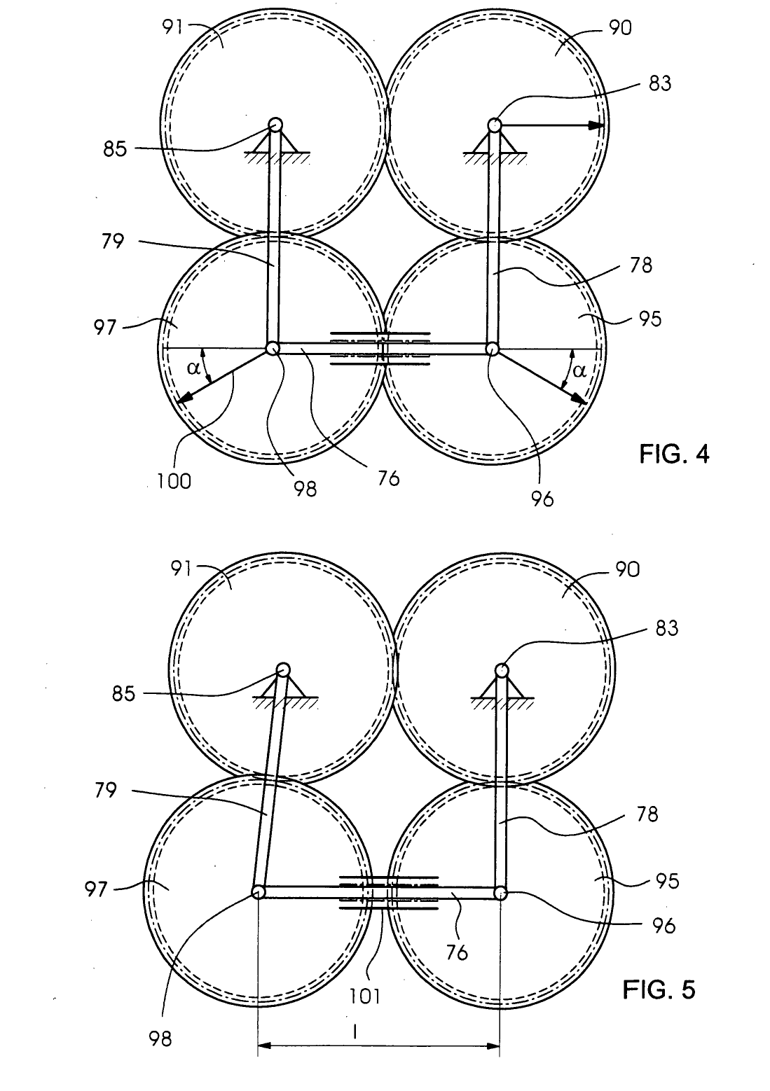

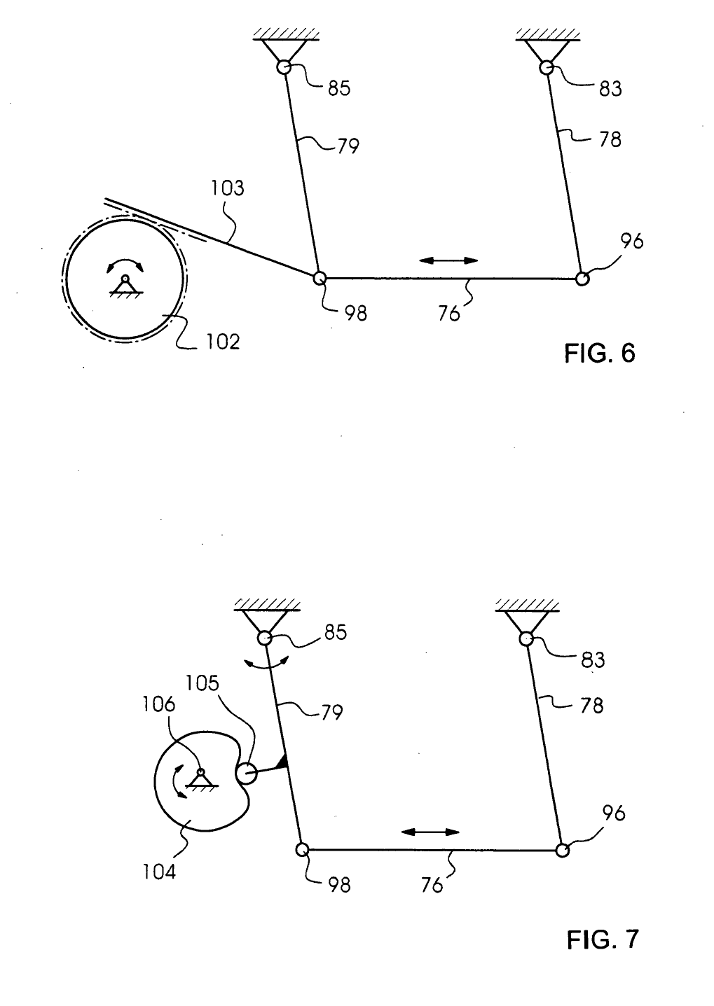

FIGS. 6 and 7 show variants of how a precision adjustment of the phase position of the gearwheels 90, 91 and the intermediate gears 95, 97 can be performed.

According to FIG. 6, a gearwheel mechanism is provided, containing a gearwheel 102 and a rack 103. The rack 103 is in engagement with the gearwheel 102. One end of the rack 103 is connected to the axle pin 98 in an articulated manner. If the gearwheel 102 is rotated, the positions of the swinging arms 78, 79 and the coupler 76 are changed.

In the variant which is shown in FIG. 7, a cam mechanism having a cam 104 and a cam roller 105 is used. The cam roller 105 is mounted on the swinging arm 98. If the cam 104 is rotated about an axle 106, the cam roller 105 then follows the profile of the cam 104 and the swinging arm 79 is deflected. As a result of the coupling to the axle pins 96, 98, the coupler 76 and the swinging arm 78 are also moved, so that a change in the rotational phase position of the intermediate gears 95, 96 and the gearwheels 90, 91 results.

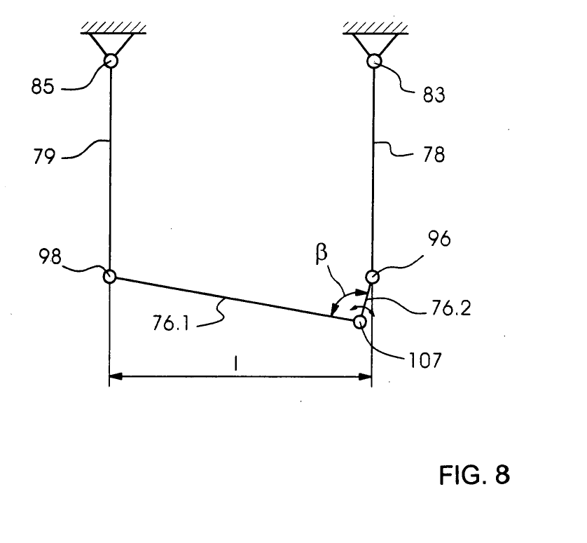

FIG. 8 shows one variant of how the coupler 76 can be extended or shortened. The coupler 76 contains a first coupler rod 76.1 and a shorter second coupler rod 76.2, which are connected to a joint 107. In each case that end of a coupler rod 76.1, 76.2 which faces away from the joint 107 is connected to the axle pins 98, 96 in an articulated manner. In order to change the coupler length l, the coupler rod 76.2 is rotated about the axle pin 96. If the angle β between the coupler rods 76.1, 76.2 is 180°, this results in a maximum coupler length lₘₐₓ, at which the intermediate gears 95, 97 are reliably out of engagement.

We claim:

1. A drive for a rotary printing press, the rotary printing press having side walls, two adjacent transfer drums, and shaft journals mounting the two adjacent transfer drums in the side walls, the drive comprising:
a gearwheel mechanism for transmitting a rotational movement of the transfer drums during transport of a printing material;
a coupler disposed in said gearwheel mechanism for producing and interrupting a transmission of torque;
at least one motor for feeding the torque into said gearwheel mechanism;
levers;
intermediate gears having teeth; and
said gearwheel mechanism having gearwheels, each of said gearwheels disposed fixedly in terms of rotation on one of the shaft journals and said gearwheels being not in direct engagement with one another, each of said gearwheels for the adjacent transfer drums being permanently in engagement in each case with one of said intermediate gears, said gearwheels for the adjacent transfer drums and said intermediate gears are kept at a spacing from one another in each case with one of said levers and said intermediate gears are kept at a spacing in each case from one another with said coupler, and in that said coupler can be disconnected and an engagement of said teeth of said intermediate gears can be canceled.

2. The drive according to claim 1, wherein when said intermediate gears are in engagement with one another, said coupler and said levers can be pivoted about axes of the shaft journals.

3. The drive according to claim 2, further comprising a positioning apparatus (99, 102, 103, 104, 105) acting on a kinematic chain formed of said levers and said coupler.

4. The drive according to claim 1, wherein during a printing operation of the rotary printing press, said intermediate gears are in engagement and a kinematic chain formed of said levers and said coupler is fixed on one of the side walls of rotary the printing press.

5. A drive for a rotary printing press having side walls, the drive comprising:
a gearwheel mechanism for transmitting a rotational movement of the transfer drums during transport of a printing material;
a coupler disposed in said gearwheel mechanism for producing and interrupting a transmission of torque;
at least one motor for feeding the torque into said gearwheel mechanism;
two adjacent transfer drums having shaft journals mounting said two adjacent transfer drums in the side walls;
levers;
intermediate gears having teeth; and
said gearwheel mechanism having gearwheels, each of said gearwheels disposed fixedly in terms of rotation on one of said shaft journals and said gearwheels being not in direct engagement with one another, each of said gearwheels for said adjacent transfer drums being permanently in engagement in each case with one of said intermediate gears, said gearwheels for said adjacent transfer drums and said intermediate gears are kept at a spacing from one another in each case with one of said levers and said intermediate gears are kept at a spacing in each case from one another with said coupler, and in that said coupler can be disconnected and an engagement of said teeth of said intermediate gears can be canceled.
